(19) United States
(12) Patent Application Publication
(10) Pub. No.: US 2025/0220586 A1
(43) Pub. Date: Jul. 3, 2025

(54) Power Conservation in Wireless Devices

(71) Applicant: Cisco Technology, Inc., San Jose, CA (US)

(72) Inventor: Ajith Chandran, Milpitas, CA (US)

(21) Appl. No.: 18/795,053

(22) Filed: Aug. 5, 2024

Related U.S. Application Data
(60) Provisional application No. 63/616,437, filed on Dec. 29, 2023.

(51) Int. Cl. H04W 52/02

(52) U.S. Cl. CPC H04W 52/0258

(57) ABSTRACT

Devices, networks, systems, methods, and processes for facilitating power conservation in wireless devices are described herein. An access point (AP) in a wireless network may predict sensor data associated with a wireless device based on historical sensor data and various parameters associated with the wireless device. The AP predicts the sensor data when a transceiver of the wireless device is operating in a sleep mode. A wake-up radio of the wireless device that consumes less power than the transceiver is awake when the transceiver is operating in the sleep mode. The AP transmits the predicted sensor data to the wake-up radio. The wake-up radio maintains the transceiver in the sleep mode in response to the predicted sensor data deviating from actual sensor data, that is generated by a sensor of the wireless device, below a threshold value, thereby conserving power of the wireless device.

The present disclosure relates to wireless devices. More particularly, the present disclosure relates to power conservation in wireless devices.

This application claims the benefit of U.S. Provisional Patent Application No. 63/616,437, filed Dec. 29, 2023, which is incorporated by reference herein in its entirety.

### BACKGROUND

In modern wireless communication systems, the efficiency and longevity of wireless devices are paramount. The proliferation of Internet of Things (IoT) devices and the increasing demand for always-on connectivity has led to a growing need to optimize the power consumption of wireless devices. IoT devices, often battery-powered, rely on efficient power management to prolong their operational life. IoT devices that continually operate at full power can deplete energy resources rapidly, leading to increased operational costs and environmental impact.

Traditional IoT devices are operable in various operational modes, such as wake mode and sleep mode, to conserve energy. Each IoT device has multiple target wake times, which are specific time intervals when an IoT device switches to wake mode to participate in data transmission. These modes are defined to balance the need for connectivity with necessity of energy conservation.

However, IoT devices often wake up and transmit data during every target wake time, even when data transmission is not required. This unnecessary activity reduces the overall energy efficiency of the IoT devices, leading to quicker depletion of their battery resources and undermining the benefits of power management strategies.

### SUMMARY OF THE DISCLOSURE

Systems and methods for power conservation in wireless devices in accordance with embodiments of the disclosure are described herein. In some embodiments, a device includes a transceiver operable in one of a sleep mode or a wake mode, a sensor configured to sense at least one parameter, and generate actual sensor data based on the at least one sensed parameter, and a wake-up logic configured to receive predicted sensor data, compare the predicted sensor data with the actual sensor data, and determine whether to switch the transceiver from the sleep mode to the wake mode based on the comparison between the predicted sensor data and the actual sensor data.

In some embodiments, an antenna is coupled to the wake-up logic.

In some embodiments, the antenna is configured to receive the predicted sensor data, and provide the predicted sensor data to the wake-up logic.

In some embodiments, the device is associated with a scheduled target wake time.

In some embodiments, the predicted sensor data is received during the scheduled target wake time.

In some embodiments, the predicted sensor data is received prior to the scheduled target wake time.

In some embodiments, a memory is coupled to the wake-up logic, wherein the memory is configured to store the predicted sensor data in response to receiving the predicted sensor data prior to the scheduled target wake time.

In some embodiments, prior to the comparison of the predicted sensor data with the actual sensor data, the wake-up logic is further configured to retrieve the predicted sensor data from the memory.

In some embodiments, the wake-up logic is further configured to retrieve the predicted sensor data from the memory during the scheduled target wake time.

In some embodiments, the sensor senses the at least one parameter and generates the actual sensor data during the scheduled target wake time.

In some embodiments, the wake-up logic determines whether to switch the transceiver from the sleep mode to the wake mode during the scheduled target wake time.

In some embodiments, the wake-up logic is further configured to transmit a notification signaling that the transceiver is operating in the sleep mode, and wherein the predicted sensor data is received in response to transmitting the notification.

In some embodiments, the wake-up logic determines to maintain the transceiver in the sleep mode in response to the predicted sensor data deviating from the actual sensor data below a threshold value.

In some embodiments, the wake-up logic determines to switch the transceiver from the sleep mode to the wake mode in response to the predicted sensor data deviating from the actual sensor data beyond a threshold value.

In some embodiments, in response to being switched to the wake mode, the transceiver is configured to transmit the actual sensor data.

In some embodiments, a wake-up logic is configured to receive, from a network device, a notification signaling that the network device is operating in a sleep mode, predict, in response to receiving the notification, sensor data associated with the network device, and transmit the predicted sensor data to the network device, wherein a determination to switch the network device from the sleep mode to a wake mode is based on the predicted sensor data.

In some embodiments, the wake-up logic is further configured to determine one or more parameters associated with the network device, provide the one or more parameters as an input to a trained machine learning model, and obtain, based on the one or more parameters, the predicted sensor data as an output of the trained machine learning model.

In some embodiments, the one or more parameters include at least one of a location of the network device, a time of day, one or more environmental conditions associated with the network device, or a scheduled target wake time associated with the network device.

In some embodiments, the wake-up logic is further configured to train the machine learning model based on historical sensor data associated with the network device and at least one of a location, a time of day, one or more environmental conditions, or a scheduled target wake time corresponding to the historical sensor data.

In some embodiments, a method includes sensing at least one parameter, generating actual sensor data based on the at least one sensed parameter, receiving predicted sensor data, comparing the predicted sensor data with the actual sensor data, and determining whether to switch a transceiver of a device from a sleep mode to a wake mode based on the comparison between the predicted sensor data and the actual sensor data.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless network in accordance with various embodiments of the disclosure;

FIG. 2 is a conceptual illustration of an artificial neural network in accordance with various embodiments of the disclosure;

FIG. 3 is a schematic block diagram of a wireless network in accordance with various embodiments of the disclosure;

FIG. 4 is a flowchart showing a process for power conservation in a wireless device in accordance with various embodiments of the disclosure;

FIG. 5 is a flowchart showing a process for power conservation in a wireless device in accordance with various embodiments of the disclosure;

FIG. 6 is a flowchart showing a process for power conservation in a wireless device in accordance with various embodiments of the disclosure;

FIG. 7 is a flowchart showing a process for facilitating power conservation in a wireless device in accordance with various embodiments of the disclosure; and

FIG. 8 is a conceptual block diagram of a device suitable for configuration with a wake-up logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that facilitate power conservation in wireless devices, for example, ultra-low power sensors, Internet of Things (IoT) devices, etc. Wireless devices (e.g., ultra-low power sensors) play an important role in a wide range of applications (e.g., environmental monitoring, healthcare, industrial automation, smart home systems, or the like). The 802.11ax standard, also known as Wi-Fi 6, incorporates a Target Wake Time (TWT) scheduling feature, which facilitates significant power conservation in wireless devices. For example, TWT scheduling allows a wireless device to negotiate wake and sleep times with an associated access point. Despite the advancements offered by TWT scheduling, there is still potential for further optimization to enhance the overall energy efficiency of these wireless devices. Various embodiments of the present disclosure attempt to conserve power in wireless devices by minimizing wake-up time of the wireless devices.

In many embodiments, a wireless device may include a sensor configured to sense at least one parameter and generate sensor data based on the at least one sensed parameter. The wireless device may further include a primary transceiver (e.g., a primary or main communication radio) and a wake-up radio (e.g., a secondary radio). The primary transceiver may be responsible for data transmission and reception operations associated with the wireless device. Examples of the data transmission operations may include transmitting the sensor data, encrypting the sensor data prior to transmission, executing one or more security protocols, or the like. The primary transceiver may be operable in one of a sleep mode or a wake mode. The wake-up radio may be responsible for power conserving operations associated with the wireless device. For example, the wake-up radio may wait to listen to a wake-up signal from an associated access point (AP) and wake-up the primary transceiver based on the wake-up signal. Alternatively, the wake-up radio may allow the primary transceiver to remain in the low-power sleep mode in the absence of the wake-up signal thereby conserving power of the wireless device.

In a variety of embodiments, the wake-up signal may include predicted sensor data. The predicted sensor data may correspond to a prediction of forthcoming sensor data from the wireless device. The wake-up radio may be further integrated with a comparison unit. The comparison unit, upon receiving the predicted sensor data from the AP, may compare the predicted sensor data with the actual sensor data generated by the sensor. In a scenario where the comparison between the predicted sensor data and the actual sensor data indicates that a deviation of the predicted sensor data from the actual sensor data is less than a threshold value, the wake-up radio may allow the primary transceiver to remain in the sleep mode. However, if the comparison between the predicted sensor data and the actual sensor data indicates that the deviation of the predicted sensor data from the actual sensor data is greater than or equal to the threshold value, the wake-up radio may cause the primary transceiver to switch from the sleep mode to the wake mode. In the wake mode, the primary transceiver may execute the data transmission operations to transmit the actual sensor data to the AP. In other words, the wake-up radio is capable of maintaining the primary transceiver in the sleep mode even after receiving the wake-up signal, thus further conserving power of the wireless device. The energy efficiency of the wireless device may be optimized as a result of improved power conservation in the wireless device.

In a number of embodiments, the AP may perform polling with the connected wireless device to determine a status of the wireless device. In response, the AP may receive a notification from the wireless device indicating the status of the wireless device. The status may indicate whether the wireless device (e.g., the primary transceiver) is operating in the sleep mode or the wake mode. If the wireless device is operating in the wake mode, the AP may wait to receive the data transmitted by the wireless device. However, if the wireless device is operating in the sleep mode, the AP may predict sensor data associated with the wireless device. In more embodiments, the AP may predict the sensor data for an upcoming or an ongoing scheduled target wake time (TWT) of the wireless device. The AP may transmit the predicted sensor data to the wireless device, for example, as a part of a wake-up signal. The wireless device may only need to wake up if the predicted sensor data deviates significantly (for example, for more than the threshold value) from the actual sensor data. Thus, if the predicted sensor data does not deviate significantly from the actual sensor data, the wireless device may continue to remain in the sleep mode even during the TWT and the AP may utilize the predicted sensor data for further operations.

In yet more embodiments, the AP can predict the sensor data based on historical sensor data associated with the wireless device. For example, the AP may utilize a machine learning model trained based on the historical sensor data and at least one of a location, a time of day, one or more environmental conditions, or a scheduled TWT corresponding to the historical sensor data. The AP can provide one or more parameters associated with the upcoming or the ongoing scheduled TWT of the wireless device as an input to the trained machine learning model and obtain the predicted sensor data as an output of the trained machine learning model. The one or more parameters may include at least one of a location of the wireless device, a time of day, one or more environmental conditions associated with the wireless device, or the scheduled TWT associated with the wireless device. In numerous embodiments, the AP may be configured to train the machine learning model. In numerous additional embodiments, the machine learning model can be trained at another device and the AP may be configured to run a local version of the machine learning model for sensor data prediction.

As a result of above described embodiments, a duration of the sleep mode of the primary transceiver may be increased, thereby resulting in enhanced power conservation in the wireless device. Additionally, unnecessary switching of the primary transceiver from the sleep mode to the wake mode is prevented. Thus, the operational life of the wireless device, such as ultra-low power sensors and IoT devices, can be improved in comparison to the operational life of conventional wireless devices, benefitting applications requiring prolonged battery life and efficient power management, for example, HaLow applications. Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not be limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in further embodiments, may alternatively be embodied by or implemented as a component.

A circuit, as used herein, comprises a set of one or more electrical and/or electronic components providing one or more pathways for electrical current. In further embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in further embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

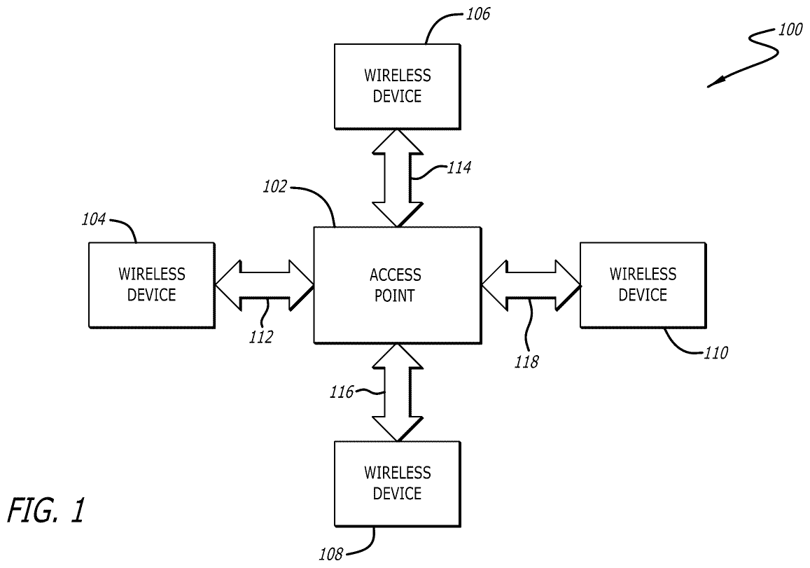

Referring to FIG. 1, a schematic block diagram of a wireless network 100 in accordance with various embodiments of the disclosure is shown. In the embodiments depicted in FIG. 1, the wireless network 100 is shown to include an access point (AP) 102 and a plurality of wireless devices, for example, wireless devices 104-110. The wireless devices 104-110 may be coupled to the AP 102 by way of communication channels 112-118, respectively. Examples of the wireless network 100 may include a wireless local area network, a worldwide interoperability for microwave access network, a network that complies with the Institute of Electrical and Electronics Engineers (IEEE) 802.11 standard, or the like. Hereinafter, the wireless devices 104-110 may be collectively referred to as “the plurality of wireless devices 104-110”.

In many embodiments, the AP 102 may be configured to facilitate connection between the plurality of wireless devices 104-110 and a wired network. Examples of the wired network may include a local area network, a data center, or the like. Further, the AP 102 can be a network device configured to provide access to the plurality of wireless devices 104-110 to a larger network, such as the Internet.

In a number of embodiments, the AP 102 may be further configured to perform polling with the plurality of wireless devices 104-110. Polling may refer to a process where the AP 102 actively determines a status of the plurality of wireless devices 104-110. For example, in order to determine whether a wireless device is operating in a sleep mode or a wake mode, the AP 102 may poll the wireless device. In response to polling, the AP 102 may be configured to receive a notification from each of the plurality of wireless devices 104-110. Each notification may indicate a current status of the corresponding wireless device. For example, a notification from the wireless device 104 may indicate whether the wireless device 104 is in the sleep mode or the wake mode. In still yet additional embodiments, the notification may include a frame control field which indicates the status of the corresponding wireless device. For example, a value of a power management bit in the frame control field when set to one (“1”) may indicate that the wireless device 104 is in the sleep mode. However, the value of the power management bit in the frame control field when set to zero (“0”) may indicate that the wireless device 104 is in the wake mode. In numerous embodiments, a value of a power management bit in the frame control field when set to zero (“0”) may indicate that the wireless device 104 is in the sleep mode. However, the value of the power management bit in the frame control field when set to one (“1”) may indicate that the wireless device 104 is in the wake mode. In a variety of embodiments, a wireless device in the sleep mode may be incapable of data transmission to the AP 102 whereas a wireless device in the wake mode may be capable of data transmission. Further, the sleep mode may also be referred to as a power saving mode.

In several additional embodiments, if the notification received from a wireless device (e.g., any of the plurality of wireless devices 104-110) indicates that the wireless device is in the sleep mode, the AP 102 may be configured to predict sensor data associated with the wireless device. For the sake of ongoing discussion, it is assumed that the notification received from the wireless device 104 indicates that the wireless device 104 is in the sleep mode. To predict the sensor data associated with the wireless device 104, the AP 102 may be configured to determine one or more parameters associated with the wireless device 104. The AP 102 may be further configured to provide the one or more parameters as an input to a trained machine learning model and obtain the predicted sensor data as an output of the trained machine learning model. The one or more parameters may include at least one of a location of the wireless device, a time of day, one or more environmental conditions associated with the wireless device, or a scheduled target wake time (TWT) associated with the wireless device. That is to say, the AP 102 may predict the sensor data of the wireless device 104 for an upcoming scheduled TWT or an ongoing scheduled TWT. TWT may be a feature in wireless technology that allows devices (such as the plurality of wireless devices 104-110 and the AP 102) to agree upon scheduled intervals for data transmission. During the scheduled intervals, if required, a wireless device may enter the wake mode from the sleep mode to exchange data with a connected AP and then return to the sleep mode.

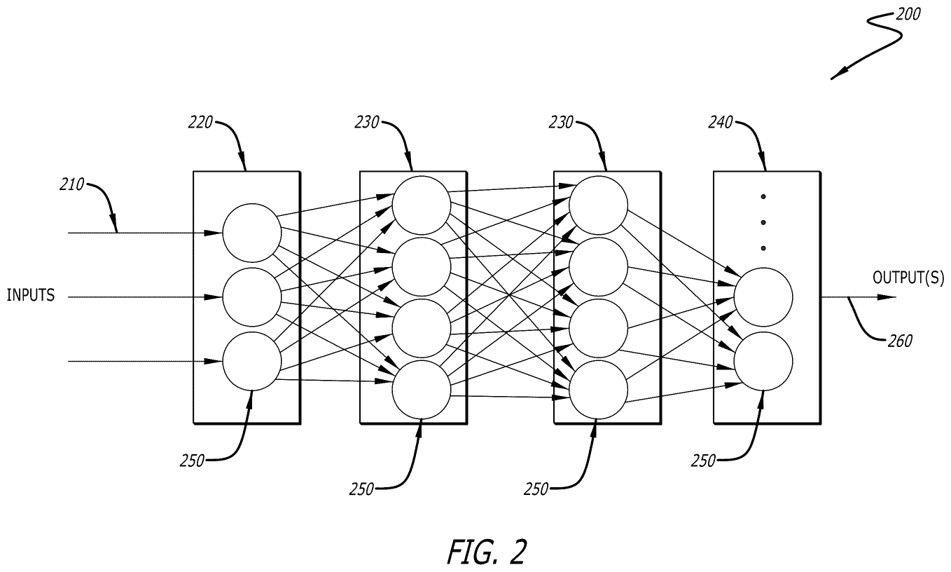

In several embodiments, the AP 102 may be configured to train a machine learning model to generate the trained machine learning model. The machine learning model may be trained based on historical sensor data received from each of the plurality of wireless devices 104-110 and at least one of a location of the corresponding wireless device, a time of day, one or more environmental conditions associated with the corresponding wireless device, or a scheduled TWT corresponding to the historical sensor data. The historical sensor data may refer to sensor data generated by a sensor in a wireless device during past scheduled TWTs associated with the corresponding wireless device. In an example, the sensor data generated by the sensor in past thirty days may correspond to the historical sensor data. In another example, the sensor data generated by the sensor in the past year may correspond to the historical sensor data. A location of a wireless device may correspond to at least one of a latitude and a longitude associated with the wireless device, a distance from the AP 102, or the like. One or more environmental conditions may include weather conditions (such as rain, humidity, fog, or snow), temperature, environmental noise, network congestion, physical obstacles, or the like. In an example scenario, the AP 102 may collect sensor data received from each of the plurality of wireless devices 104-110 during their past scheduled TWTs and utilize the collected sensor data to train the machine learning model. In numerous additional embodiments, the AP 102 may store the machine learning model locally for execution. The training of the machine learning model is described in detail in conjunction with FIG. 2.

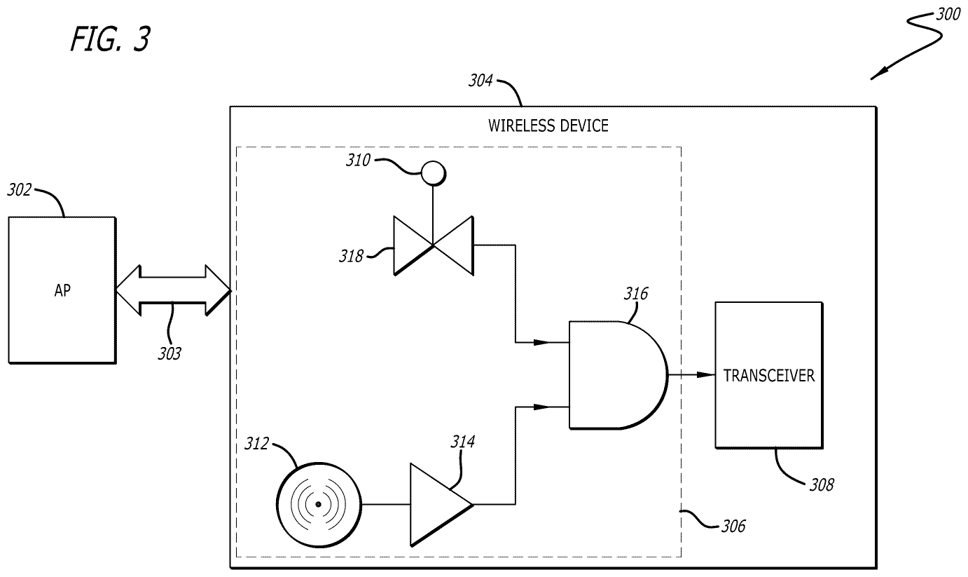

In many further embodiments, the AP 102 may be further configured to transmit the predicted sensor data to the wireless device 104. For example, the AP 102 may transmit the predicted sensor data to the wireless device 104 in a wake-up signal. Further, a determination to switch the wireless device 104 from the sleep mode to the wake mode may be based on the predicted sensor data. Operation of a wireless device is described in detail in conjunction with FIG. 3.

In still further embodiments, the AP 102 may poll the wireless device 104 based on a scheduled TWT associated with the wireless device 104. For example, the AP 102 may poll the wireless device 104 at a time that is closer to the scheduled TWT of the wireless device 104. If the notification received in response to the polling indicates that the wireless device 104 is in the sleep mode, the AP 102 may predict the sensor data associated with the wireless device 104 and transmit the predicted sensor data to the wireless device 104 prior to the scheduled TWT or during the scheduled TWT. In still more embodiments, the AP 102 may predict sensor data for each scheduled TWT associated with the wireless device 104 and store the predicted sensor data for each scheduled TWT in a memory associated with the AP 102. Further, upon receiving the notification that indicates that the wireless device 104 is in the sleep mode, the AP 102 may retrieve the predicted sensor data associated with a corresponding scheduled TWT from the memory and transmit the predicted sensor data to the wireless device 104.

In additional embodiments, each of the plurality of wireless devices 104-110 may be configured to communicate with the AP 102. Examples of the plurality of wireless devices 104-110 may include an Internet of Things (IoT) device, a low power sensor, an ultra-low power sensor, a smartphone, a computer, a laptop, a network node, or the like. Each of the plurality of wireless devices 104-110 may perform a negotiation with the AP 102 to establish a corresponding TWT schedule. As a result of the negotiation, each of the plurality of wireless devices 104-110 may be associated with a corresponding set of scheduled TWTs.

In more embodiments, each of the plurality of wireless devices 104-110 may include at least one sensor. A sensor may be a device or a module configured to detect or sense one or more physical or environmental parameters and generate sensor data for measurement, analysis, or monitoring purposes. Examples of a sensor may include a temperature sensor, a humidity sensor, a pressure sensor, a proximity sensor, a motion sensor, a light sensor, a sound sensor, a soil moisture sensor, a heart rate sensor, an ultrasonic sensor, or the like.

Although it is described that the sensor data is predicted for the wireless device 104, the scope of the present disclosure is not limited to it. In further embodiments, sensor data may be predicted for the other wireless devices 106-110 as predicted for the wireless device 104.

Although a specific embodiment of a wireless network suitable for carrying out the various steps, processes, methods, and operations described herein is discussed with respect to FIG. 1, any of a variety of systems and/or processes may be utilized in accordance with embodiments of the disclosure. For some examples, in still yet further embodiments, the AP 102 may provide historical sensor data received from the plurality of wireless devices 104-110 to a cloud server or any other server for training the machine learning model and the AP 102 can receive a local version of the trained machine learning model for execution. In some more embodiments, the AP 102 may receive the predicted sensor data from the cloud server as compared to receiving the local version of the trained machine learning model. The elements depicted in FIG. 1 may also be interchangeable with other elements of FIGS. 2-8 as required to realize a particularly desired embodiment.

Referring to FIG. 2, a conceptual illustration of an artificial neural network 200 in accordance with various embodiments of the disclosure is shown. As those skilled in the art will recognize, various methods of machine learning models can be utilized to achieve desired outcomes efficiently. For example, several embodiments may utilize decision trees, random forests, support vector machines, naïve Bayes, Seasonal and Trend decomposition using Loess, or K-nearest neighbors' algorithms. However, artificial neural networks have increased in popularity, especially in deep learning techniques where detection of complex patterns in data and the ability to solve a wide range of problems has been desired. In various embodiments, an artificial neural network may be utilized. Artificial neural networks are a type of machine learning model inspired by the structure and function of the human brain, and often consist of three main types of layers: the input layer, the output layer, and one or more intermediate (also called hidden) layers.

In many embodiments, the input layer is responsible for receiving input data, which could be anything from an image to a text document to numerical values. Each input feature can be represented by a node in the input layer. Conversely, the output layer is often responsible for producing the output of the network, which could be, for example, a prediction or a classification. The number of nodes in the output layer can depend on the task at hand. For example, if the task is to classify images into ten different categories, there would be ten nodes in the output layer, each representing a different category.

The intermediate layers are where the specialized connections are made. These intermediate layers are responsible for transforming the input data in a non-linear way to extract meaningful features that can be used for the final output. In various embodiments, a node in an intermediate layer can take as an input a weighted sum of the outputs from the previous layer, apply a non-linear activation function to it, and pass the result on to the next layer. The weights of the connections between nodes in the layers are learned during training. This training can utilize backpropagation, which may involve calculating the gradient of the error with respect to the weights and adjusting the weights accordingly to minimize the error.

At a high level, the artificial neural network 200 depicted in the embodiment of FIG. 2 includes a number of inputs 210, an input layer 220, one or more intermediate layers 230, and an output layer 240. The artificial neural network 200 may comprise a collection of connected units or nodes called artificial neurons 250, which loosely model the neurons in a biological brain. Each connection, like the synapses in a biological brain, can transmit a signal from one artificial neuron to another. An artificial neuron that receives a signal can process the signal and then trigger additional artificial neurons within the next layer of the neural network. As those skilled in the art will recognize, the artificial neural network 200 depicted in FIG. 2 is shown as an illustrative example, and various embodiments may comprise artificial neural networks that can accept more than one type of input and can provide more than one type of output.

In many further embodiments, the signal at a connection between artificial neurons is a value, and the output of each artificial neuron is computed by some nonlinear function (called an activation function) of the sum of the artificial neuron's inputs. Often, the connections between artificial neurons are called “edges” or axons. Artificial neurons and edges typically have a weight that adjusts as learning proceeds. The weight increases or decreases the strength of the signal at a connection. Artificial neurons may have a threshold (trigger threshold) such that the signal is only sent if the aggregate signal crosses that threshold. Typically, artificial neurons are aggregated into layers. Different layers may perform different kinds of transformations on their inputs. Signals propagate from the first layer (the input layer 220) to the last layer (the output layer 240), possibly after traversing one or more intermediate layers (also called hidden layers) 230.

The inputs to an artificial neural network may vary depending on the problem being addressed. In object detection for example, the inputs may be data representing values for certain corresponding actual measurements or values within the object to be detected. In one embodiment, the artificial neural network 200 comprises a series of hidden layers in which each neuron is fully connected to neurons of the next layer. The artificial neural network 200 may utilize an activation function such as sigmoid, nonlinear, or a rectified linear unit (ReLU), upon the sum of the weighted inputs, for example. The last layer in the artificial neural network 200 may implement a regression function to produce the classified or predicted classifications output for object detection as output. In further embodiments, a sigmoid function can be used, and the prediction may need raw output transformation into linear and/or nonlinear data.

Embodiments of the disclosure may include training the artificial neural network 200 based on historical sensor data associated with a wireless device (for example, any of the plurality of wireless devices 104-110 shown in FIG. 1) and at least one of a location, a time of day, one or more environmental conditions, or a scheduled TWT corresponding to the historical sensor data. Upon training the artificial neural network 200, the artificial neural network 200 may be referred to as “the trained artificial neural network 200”. The trained artificial neural network 200 may be utilized by an AP connected to the wireless device to predict sensor data associated with the wireless device. The AP may determine one or more parameters associated with the wireless device and provide one or more parameters associated with the wireless device as an input to the trained artificial neural network 200 and obtain the predicted sensor data as an output of the trained artificial neural network 200.

In numerous embodiments, the one or more parameters may include at least one of a location of the wireless device, a time of day, one or more environmental conditions associated with the wireless device, or a scheduled TWT associated with the wireless device. In an example, the sensor data may correspond to a temperature value. In such a scenario, the artificial neural network 200 may be trained based on historical temperature values associated with the wireless device. Further, when the AP receives the notification signaling that the wireless device is operating in the sleep mode, the AP may determine the location of the wireless device, a time of day, and the scheduled TWT associated with the wireless device. Further, the AP may provide the location of the wireless device 104, the time of day, and the scheduled TWT associated with the wireless device as an input to the trained artificial neural network 200. The trained artificial neural network 200 may predict the temperature value based on the input. Further, the AP may obtain the predicted temperature value as the output of the trained artificial neural network 200.

Although a specific embodiment for an artificial neural network machine learning model suitable for carrying out the various steps, processes, methods, and operations described herein is discussed with respect to FIG. 2, any of a variety of systems and/or processes may be utilized in accordance with embodiments of the disclosure. For example, the trained artificial neural network 200 may be external operated, such as through a cloud-based service, or a third-party service. In several embodiments, the trained artificial neural network 200 may correspond to a hybrid machine learning model. In an example, the hybrid machine learning model may combine capabilities of Random Forest and Seasonal and Trend decomposition using Loess. The elements depicted in FIG. 2 may also be interchangeable with other elements of FIGS. 1 and 3-8 as required to realize a particularly desired embodiment.

Referring to FIG. 3, a schematic block diagram of a wireless network 300 in accordance with various embodiments of the disclosure is shown. In the embodiments depicted in FIG. 3, the wireless network 300 is shown to include an AP 302 and a wireless device 304. The wireless device 304 may be coupled to the AP 302 by way of a communication channel 303. Examples of the wireless network 300 may include a wireless local area network, a worldwide interoperability for microwave access network, a network that complies with the Institute of Electrical and Electronics Engineers (IEEE) 802.11 standard, or the like.

The AP 302 may be configured to facilitate connection between the wireless device 304 and a wired network. Examples of the wired network may include a local area network, a data center, or the like. Further, the AP 302 can be a network device configured to provide access to the wireless device 304 to a larger network, such as the Internet.

The wireless device 304 may include a wake-up radio 306 and a transceiver 308. The wake-up radio 306 may be a low power component in comparison to the transceiver 308. In other words, the wake-up radio 306 may consume low power in comparison to the transceiver 308. Further, the wireless device 304 may be operable in one of a sleep mode and a wake mode to enhance power saving in the wireless device 304. The transceiver 308 may be inactive when the wireless device 304 is operating in the sleep mode. Thus, the wireless device 304 is unable to transmit data to the AP 302 during the sleep mode. Additionally, the wake-up radio 306 may be active when the wireless device 304 is operating in the sleep mode. The transceiver 308 may be active when the wireless device 304 is operating in the wake mode. Thus, the wireless device 304 may transmit data to the AP 302 when the wireless device 304 is operating in the wake mode. Examples of the wireless device 304 may include an IoT device, a low power sensor, an ultra-low power sensor, a smartphone, a computer, a laptop, or the like.

The wireless device 304 may be configured to communicate with the AP 302 in the wireless network 300 to facilitate various operations. The wireless device 304 may be configured to negotiate with the AP 302 to establish a set of scheduled TWTs during an initial set-up of the wireless device 304. A scheduled TWT may refer to the time interval during which the transceiver 308 may be configured to operate in the wake mode based on an activation signal received from the wake-up radio 306. The activation signal may indicate the transceiver 308 to switch from the sleep mode to the wake mode. The wake-up radio 306 may include an antenna 310, a sensor 312, a memory 314, a comparison unit 316, and a threshold detector 318.

The sensor 312 may be configured to sense at least one parameter and generate actual sensor data based on the at least one sensed parameter. Examples of the sensor 312 may include a temperature sensor, a humidity sensor, a pressure sensor, a proximity sensor, a motion sensor, a light sensor, a sound sensor, a soil moisture sensor, a heart rate sensor, an ultrasonic sensor, or the like. In a number of embodiments, the sensor 312 may be configured to sense the at least one parameter and generate the actual sensor data, continuously. In a variety of embodiments, the sensor 312 may be configured to sense the at least one parameter and generate the actual sensor data in periodic intervals. In further additional embodiments, the at least one parameter may correspond to raw data and the generated sensor data may correspond to one of a set of electrical signals (such as a voltage signal), a set of digital signals, or the like.

The wireless device 304 may be further configured to receive a polling request from the AP 302 when the AP 302 performs polling. In response, the wireless device 304 may be configured to transmit a notification to indicate a current status of the wireless device 304. For the sake of ongoing discussion, it is assumed that the transceiver 308 is operating in the sleep mode while receiving the polling request. Thus, the wireless device 304 may be configured to transmit the notification signaling that the transceiver 308 is operating in the sleep mode. In many embodiments, the notification may correspond to a data packet. The data packet may include a header which may include a frame control field. The frame control field may include a power management bit. In still yet additional embodiments, the wireless device 304 may be configured to set a value of the power management bit to one (“1”) to indicate that the transceiver 308 may be operating in the sleep mode. In numerous embodiments, the wireless device 304 may be configured to set a value of the power management bit to zero (“0”) to indicate that the transceiver 308 may be operating in the sleep mode.

In additional embodiments, the antenna 310 may be configured to receive predicted sensor data from the AP 302 in response to the notification. Further, the antenna 310 may be configured to provide the predicted sensor data to the comparison unit 316. In other words, the comparison unit 316 may be configured to receive the predicted sensor data from the AP 302 by way of the antenna 310. In further embodiments, the comparison unit 316 may receive the predicted sensor data during a first scheduled TWT. In still more embodiments, the comparison unit 316 may receive the predicted sensor data prior to the first scheduled TWT. The first scheduled TWT is the upcoming TWT of the set of scheduled TWTs when the predicted sensor data is received by the comparison unit 316. In such embodiments, the memory 314 may be configured to store the predicted sensor data. In more embodiments, the comparison unit 316 may be configured to receive predicted sensor data for each of the set of scheduled TWTs associated with the wireless device 304. Further, the memory 314 may be configured to store the predicted sensor data for each of the set of scheduled TWTs. In other words, the memory 314 may store a mapping between the predicted sensor data and each of the set of scheduled TWTs. Examples of the memory 314 may include random access memory (RAM), read-only memory (ROM), flash memory, programmable ROM, electronically erasable PROM, static RAM, dynamic RAM, a buffer circuit, or the like.

In various embodiments, the comparison unit 316 may be configured to compare the predicted sensor data with the actual sensor data. Particularly, the comparison unit 316 may be configured to compare the predicted sensor with the actual sensor data during the first scheduled TWT. In yet more embodiments, the comparison unit 316 may be configured to retrieve the predicted sensor data from the memory 314 prior to the comparison of the predicted sensor data with the actual sensor data. The predicted sensor data may be retrieved from the memory 314 during the first scheduled TWT. In yet several more embodiments, the comparison unit 316 may be further configured to transmit a trigger signal to the sensor 312 to trigger the generation of the actual sensor data. In response, the sensor 312 may sense the at least one parameter and generate the actual sensor data during the first scheduled TWT. The sensor 312 may further provide the generated actual sensor data to the comparison unit 316Examples of the comparison unit 316 may include a digital comparator, an analog comparator, a microcontroller integrated comparator, a digital signal processing comparator, an op-amp based comparator, an integrated reference with comparator, a differential comparator, low voltage comparator, or the like. In yet further embodiments, the comparison unit 316 may include a comparator and a processor. Examples of the processor may include an application-specific integrated circuit (ASIC) processor, a reduced instruction set computer (RISC) processor, a complex instruction set computer (CISC) processor, a field programmable gate array (FPGA), a central processing unit (CPU), or the like.

The comparison unit 316 may be further configured to determine whether to switch the transceiver 308 from the sleep mode to the wake mode based on the comparison between the predicted sensor data and the actual sensor data. In many further embodiments, the comparison unit 316 may determine to maintain the transceiver 308 in the sleep mode in response to a deviation of the predicted sensor data from the actual sensor data falling below a threshold value. Particularly, the comparison unit 316 may abstain from sending the activation signal to the transceiver 308. The predicted sensor data deviating from the actual sensor data below the threshold value may indicate that a prediction by the AP 302 about sensor data is accurate. Thus, the switching of the transceiver 308 from the sleep mode to the wake mode is prevented. Further, transmission of the actual sensor data by the transceiver 308 to the AP 302 is prevented as the transceiver 308 remains in the sleep mode. As a result, power conservation in the wireless device 304 occurs as the transceiver 308 is maintained in the sleep mode. Additionally, the operational life of the wireless device 304 is prolonged due to the power conservation. Further, energy efficiency of the wireless device 304 is optimized as a result of power conservation. In many additional embodiments, the AP 302 may consider the predicted sensor data as the actual sensor data in the absence of reception of the actual sensor data from the wireless device 304 in the first scheduled TWT. Further, the predicted sensor data may be utilized by the AP 302 for further operations.

In yet additional embodiments, the comparison unit 316 may determine to switch the transceiver 308 from the sleep mode to the wake mode in response to the predicted sensor data deviating from the actual sensor data beyond the threshold value. Particularly, the comparison unit 316 may send the activation signal to the transceiver 308. In such embodiments, the transceiver 308 may be configured to transmit the actual sensor data to the AP 302 in response to being switched to the wake mode. In several embodiments, the transceiver 308 may be further configured process and encrypt the actual sensor data and transmit the processed and encrypted actual sensor data to the AP 302. In numerous additional embodiments, the transceiver 308 may be configured to include an antenna (not shown) to facilitate the transmission of the actual sensor data to the AP 302.

In a variety of additional embodiments, a wake-up signal received by the antenna 310 may include the predicted sensor data. Further, the threshold detector 318 may be configured to receive the wake-up signal from the antenna 310. The threshold detector 318 may be configured to compare signal strength of the wake-up signal with threshold signal strength. The threshold detector 318 may send the wake-up signal to the comparison unit 316 in response to the signal strength of the wake-up signal exceeding the threshold signal strength. The signal strength of the wake-up signal may be compared with the threshold signal strength to ensure that false wake-up signals are prevented from being processed by the comparison unit 316. Examples of the threshold detector 318 may include a digital comparator, an analog comparator, a microcontroller integrated comparator, a digital signal processing comparator, an op-amp based comparator, an integrated reference with comparator, a differential comparator, low voltage comparator, or the like.

Although a specific embodiment of a wireless device with reduced wake-up time suitable for carrying out the various steps, processes, methods, and operations described herein is discussed with respect to FIG. 3, any of a variety of systems and/or processes may be utilized in accordance with embodiments of the disclosure. For some examples, in still further embodiments, the wake-up radio 306 may be configured to operate in one of the sleep mode and the wake mode. Particularly, the wake-up radio 306 may be configured to operate in the wake mode during each of the set of scheduled TWTs. In such embodiments, the wake-up radio 306 may wake up during each of the set of scheduled TWTs and perform the above-described operations. The elements depicted in FIG. 3 may also be interchangeable with other elements of FIGS. 1, 2, and 4-8 as required to realize a particularly desired embodiment.

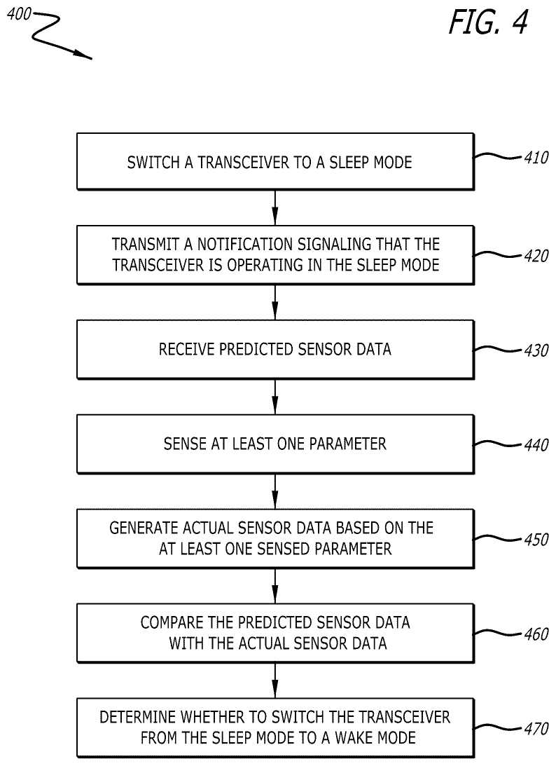

Referring to FIG. 4, a flowchart showing a process 400 for power conservation in a wireless device in accordance with various embodiments of the disclosure is shown. In many embodiments, the process 400 can switch a transceiver of a wireless device to a sleep mode (block 410). The transceiver may be operable in one of the sleep mode and a wake mode, at any given time. The transceiver may be incapable of data transmission during the sleep mode whereas the transceiver may be capable of data transmission in the wake mode. Additionally, the wireless device may be associated with a set of scheduled TWTs. A scheduled TWT may refer to the time interval during which the transceiver may be configured to operate in the wake mode based on an activation signal. Examples of the wireless device may include an IoT device, a low power sensor, an ultra-low power sensor, a smartphone, a computer, a laptop, a network node, or the like.

In a number of embodiments, the process 400 can transmit a notification signaling that the transceiver is operating in the sleep mode (block 420). The process 400 may transmit the notification to an AP in response to receiving a polling request from the AP. The AP is communicatively coupled to the wireless device. The AP may perform polling during which the polling request may be transmitted to the wireless device to determine the status of the transceiver.

In a variety of embodiments, the process 400 can receive predicted sensor data (block 430). The predicted sensor data may be received from the AP in response to the notification transmitted to the AP signaling that the transceiver is operating in the sleep mode. The predicted sensor data may correspond to a prediction of forthcoming sensor data from the wireless device. In several embodiments, the predicted sensor data may be received during one of the set of scheduled TWTs associated with the wireless device.

In more embodiments, the process 400 may sense at least one parameter (block 440). The at least one parameter may correspond to a physical parameter or an environmental parameter associated with the wireless device. Examples of the at least one parameter may include temperature, humidity, pressure, light intensity, proximity, or the like. In numerous embodiments, the wireless device may include a sensor that may be configured to sense the at least one parameter. Examples of the sensor may include a temperature sensor, a humidity sensor, a pressure sensor, a proximity sensor, a motion sensor, a light sensor, a sound sensor, a soil moisture sensor, a heart rate sensor, an ultrasonic sensor, or the like.

In additional embodiments, the process 400 can generate actual sensor data based on the at least one sensed parameter (block 450). In numerous additional embodiments, the sensed at least one parameter may correspond to raw data. In such embodiments, the sensor generates the actual sensor data that may correspond to a set of electrical signals or a set of digital signals. The sensor may process the at least one sensed parameter to generate the actual sensor data.

In yet more embodiments, the process 400 can compare the predicted sensor data with the actual sensor data (block 460). The predicted sensor data may be compared with the actual sensor data by a comparison unit of the wireless device. Examples of the comparison unit may include a digital comparator, an analog comparator, a microcontroller integrated comparator, a digital signal processing comparator, an op-amp based comparator, an integrated reference with comparator, a differential comparator, low voltage comparator, or the like.

In further embodiments, the process 400 may determine whether to switch the transceiver from the sleep mode to the wake mode based on the comparison of the predicted sensor data with the actual sensor data (block 470). The process 400 may determine to switch the transceiver from the sleep mode to the wake mode when the predicted sensor data deviates from the actual sensor data beyond a threshold value. The comparison unit may send the activation signal to the transceiver to switch the transceiver from the sleep mode to the wake mode. Alternatively, the process 400 may determine to maintain the transceiver in the sleep mode when the predicted sensor data deviates from the actual sensor data below the threshold value.

Although a specific embodiment for the process 400 for power conservation in a wireless device suitable for carrying out the various steps, processes, methods, and operations described herein is discussed with respect to FIG. 4, any of a variety of systems and/or processes may be utilized in accordance with embodiments of the disclosure. For some examples, in still more embodiments, the process 400 may sense the at least one parameter and generate the actual sensor data prior to receiving the predicted sensor data. The elements depicted in FIG. 4 may also be interchangeable with other elements of FIGS. 1-3 and 5-8 as required to realize a particularly desired embodiment.

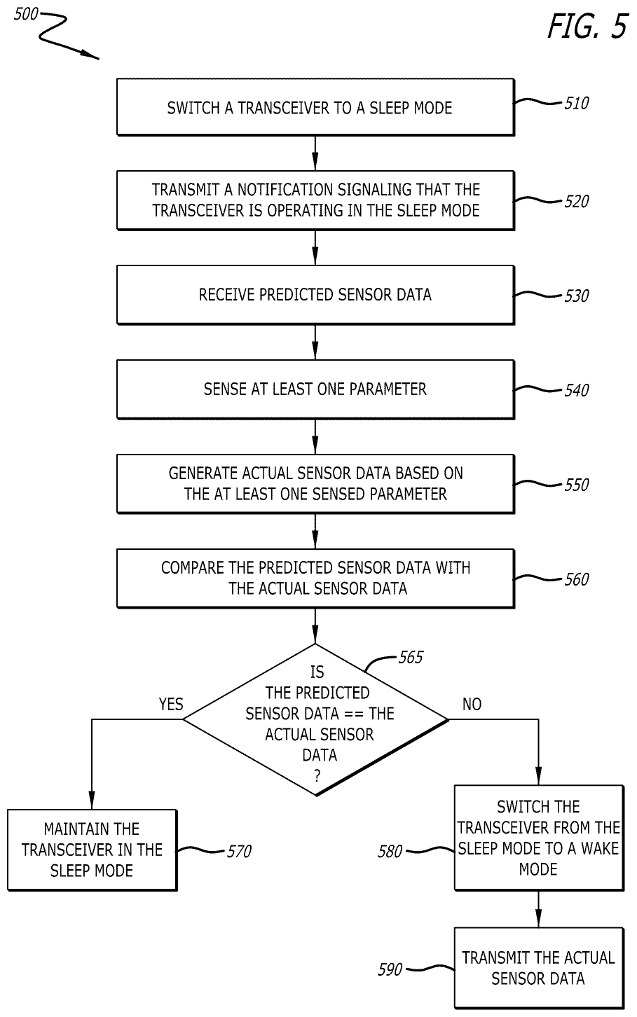

Referring to FIG. 5, a flowchart showing a process 500 for power conservation in a wireless device in accordance with various embodiments of the disclosure is shown. In many embodiments, the process 500 can switch a transceiver of a wireless device to a sleep mode (block 510). The transceiver may be operable in one of the sleep mode and a wake mode, at any given time. The transceiver may be incapable of data transmission during the sleep mode whereas the transceiver may be capable of data transmission in the wake mode. Additionally, the wireless device may be associated with a set of scheduled TWTs. A scheduled TWT may refer to the time interval during which the transceiver may be configured to operate in the wake mode based on an activation signal. Examples of the wireless device may include an IoT device, a low power sensor, an ultra-low power sensor, a smartphone, a computer, a laptop, a network node, or the like.

In a number of embodiments, the process 500 can transmit a notification signaling that the transceiver is operating in the sleep mode (block 520). The process 500 may transmit the notification to an AP in response to receiving a polling request from the AP. The AP is communicatively coupled to the wireless device. The AP may perform polling during which the polling request may be transmitted to the wireless device to determine the status of the transceiver.

In a variety of embodiments, the process 500 can receive predicted sensor data (block 530). The predicted sensor data may be received from the AP in response to the notification transmitted to the AP signaling that the transceiver is operating in the sleep mode. The predicted sensor data may correspond to a prediction of forthcoming sensor data from the wireless device. In several embodiments, the predicted sensor data may be received during one of the set of scheduled TWTs associated with the wireless device.

In more embodiments, the process 500 may sense at least one parameter (block 540). The at least one parameter may correspond to a physical parameter or an environmental parameter associated with the wireless device. Examples of the at least one parameter may include temperature, humidity, pressure, light intensity, proximity, or the like. In numerous embodiments, the wireless device may include a sensor that may be configured to sense the at least one parameter. Examples of the sensor may include a temperature sensor, a humidity sensor, a pressure sensor, a proximity sensor, a motion sensor, a light sensor, a sound sensor, a soil moisture sensor, a heart rate sensor, an ultrasonic sensor, or the like.

In additional embodiments, the process 500 can generate actual sensor data based on the at least one sensed parameter (block 550). In numerous additional embodiments, the sensed at least one parameter may correspond to raw data. In such embodiments, the sensor generates the actual sensor data that may correspond to a set of electrical signals or a set of digital signals. The sensor may process the at least one sensed parameter to generate the actual sensor data.

In yet more embodiments, the process 500 can compare the predicted sensor data with the actual sensor data (block 560). The predicted sensor data may be compared with the actual sensor data by a comparison unit of the wireless device. Examples of the comparison unit may include a digital comparator, an analog comparator, a microcontroller integrated comparator, a digital signal processing comparator, an op-amp based comparator, an integrated reference with comparator, a differential comparator, low voltage comparator, or the like. Examples of the processor may include an ASIC processor, a RISC processor, a CISC processor, a FPGA, a CPU, or the like.

In further embodiments, the process 500 may determine whether the predicted sensor data is same as the actual sensor data (block 565). The process 500 may determine whether the predicted sensor data is same as the actual sensor data based on the comparison of the predicted sensor data with the actual sensor data. In several more embodiments, the predicted sensor data may be considered to be same as the actual sensor data in response to the predicted sensor data deviating from the actual sensor data below a threshold value. In still yet embodiments, the predicted sensor data may be considered to be same as the actual sensor data when the predicted sensor data is equal to the actual sensor data.

In still more embodiments, if the predicted sensor data is determined to be same as the actual sensor data, the process 500 may maintain the transceiver in the sleep mode (block 570). As the predicted sensor data is determined to be same as the actual sensor data, transmission of the actual sensor data by the transceiver to the AP is prevented. Thus, the transceiver of the wireless device remains in the sleep mode for a longer duration, resulting in improved power efficiency of the wireless device.

In still further embodiments, if the predicted sensor data is determined to be different from the actual sensor data, the process 500 may switch the transceiver from the sleep mode to the wake mode (block 580). The predicted sensor data may be considered to be different from the actual sensor data in response to the predicted sensor data deviating from the actual sensor data beyond the threshold value. In several additional embodiments, the comparison unit may send the activation signal to the transceiver to switch the transceiver from the sleep mode to the wake mode.

In still additional embodiments, the process 500 may transmit the actual sensor data in response to being switched from the sleep mode to the wake mode (block 590). The actual sensor data may be transmitted to the AP. In many further embodiments, the transceiver may transmit the actual sensor data to the AP. In several more embodiments, the actual sensor data may be transmitted to the AP during the scheduled TWT in which the wireless device receives the predicted sensor data from the AP.

Although a specific embodiment for the process 500 for power conservation in a wireless device suitable for carrying out the various steps, processes, methods, and operations described herein is discussed with respect to FIG. 5, any of a variety of systems and/or processes may be utilized in accordance with embodiments of the disclosure. In further additional embodiments, the process 500 may sense the at least one parameter and generate the actual sensor data prior to the scheduled TWT associated with the wireless device. In such embodiments, the actual sensor data may be stored in a memory of the wireless device upon the generation. Further, the actual sensor data may be retrieved from the memory during the scheduled TWT. The elements depicted in FIG. 5 may also be interchangeable with other elements of FIGS. 1-4 and 6-8 as required to realize a particularly desired embodiment.

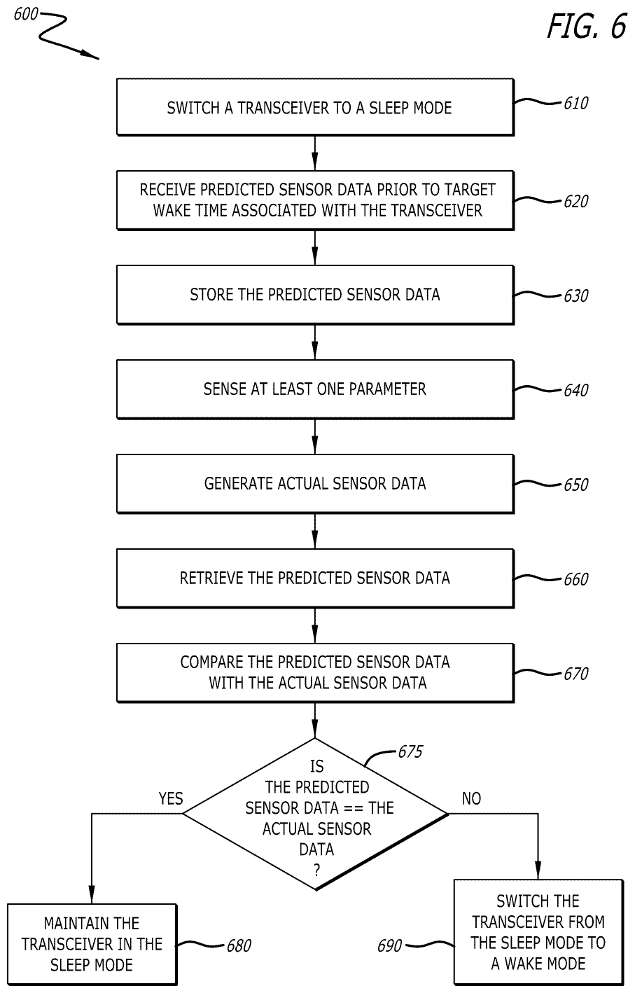

Referring to FIG. 6, a flowchart showing a process 600 for power conservation in a wireless device in accordance with various embodiments of the disclosure is shown. In many embodiments, the process 600 can switch a transceiver of a wireless device to a sleep mode (block 610). The transceiver may be operable in one of the sleep mode and a wake mode, at any given time. The transceiver may be incapable of data transmission during the sleep mode whereas the transceiver may be capable of data transmission in the wake mode. Additionally, the wireless device may be associated with a set of scheduled TWTs. A scheduled TWT may refer to the time interval during which the transceiver may be configured to operate in the wake mode based on an activation signal. Examples of the wireless device may include an IoT device, a low power sensor, an ultra-low power sensor, a smartphone, a computer, a laptop, a network node, or the like.

In a number of embodiments, a notification may be transmitted to an AP by the wireless device. The AP is communicatively coupled to the wireless device. The notification may signal that the transceiver may be operating in the sleep mode. The notification may be transmitted to the AP in response to receiving a polling request from the AP. The AP may perform polling during which the polling request may be transmitted to the wireless device to determine the status of the transceiver.

In a variety of embodiments, the process 600 can receive predicted sensor data prior to a scheduled TWT of the set of TWTs associated with the transceiver (block 620). The predicted sensor data may be received from the AP in response to the notification transmitted to the AP signaling that the transceiver is operating in the sleep mode. The predicted sensor data may correspond to a prediction of forthcoming sensor data from the wireless device.

The process 600 may store the received predicted sensor data (block 630). The predicted sensor data may be stored in a memory of the wireless device. The predicted sensor data may be stored in the memory as the predicted sensor data is received prior to the scheduled TWT. Examples of the memory may include RAM, ROM, flash memory, PROM, EEPROM, static RAM, dynamic RAM, a buffer circuit, or the like

In more embodiments, the process 600 may sense at least one parameter (block 640). The at least one parameter may correspond to a physical parameter or an environmental parameter associated with the wireless device. Examples of the at least one parameter may include temperature, humidity, pressure, light intensity, proximity, or the like. In numerous embodiments, the wireless device may include a sensor that may be configured to sense the at least one parameter. Examples of the sensor may include a temperature sensor, a humidity sensor, a pressure sensor, a proximity sensor, a motion sensor, a light sensor, a sound sensor, a soil moisture sensor, a heart rate sensor, an ultrasonic sensor, or the like.

In additional embodiments, the process 600 can generate actual sensor data based on the at least one sensed parameter (block 650). In numerous additional embodiments, the sensed at least one parameter may correspond to raw data. In such embodiments, the sensor generates the actual sensor data that may correspond to a set of electrical signals or a set of digital signals. The sensor may process the at least one sensed parameter to generate the actual sensor data. The process 600 may sense and generate the at least one parameter during the scheduled TWT.

In further embodiments, the process 600 may retrieve the predicted sensor data from the memory (block 660). The predicted sensor data may be retrieved during the scheduled TWT. In several embodiments, a comparison unit of the wireless device may retrieve the predicted sensor data from the memory.

In several more embodiments, the process 600 may compare the predicted sensor data with the actual sensor data (block 670). The predicted sensor data may be compared with the actual sensor data upon the retrieval of the predicted sensor data from the memory. The predicted sensor data may be compared with the actual sensor data by the comparison unit.

In still more embodiments, the process 600 may determine whether the predicted sensor data is same as the actual sensor data (block 675). The process 600 may determine whether the predicted sensor data is same as the actual sensor data based on the comparison of the predicted sensor data with the actual sensor data. In further embodiments, the predicted sensor data may be considered to be same as the actual sensor data in response to the predicted sensor data deviating from the actual sensor data below a threshold value. In still additional embodiments, the predicted sensor data may be considered to be same as the actual sensor data when the predicted sensor data is equal to the actual sensor data.

In still yet more embodiments, if the predicted sensor data is determined to be same as the actual sensor data, the process 600 may maintain the transceiver in the sleep mode (block 680). As the predicted sensor data is determined to be same as the actual sensor data, transmission of the actual sensor data by the transceiver to the AP is prevented. Thus, the transceiver of the wireless device remains in the sleep mode for a longer duration resulting in improved power efficiency of the wireless device.

In still further embodiments, if the predicted sensor data is determined to be different from the actual sensor data, the process 600 may switch the transceiver from the sleep mode to the wake mode (block 690). The predicted sensor data may be considered to be different from the actual sensor data in response to the predicted sensor data deviating from the actual sensor data beyond the threshold value. In several additional embodiments, the comparison unit may send the activation signal to the transceiver to switch the transceiver from the sleep mode to the wake mode. In many further embodiments, the actual sensor data may be transmitted to the AP in response to the transceiver being switched from the sleep mode to the wake mode.

Although a specific embodiment for the process 600 for power conservation in a wireless device suitable for carrying out the various steps, processes, methods, and operations described herein is discussed with respect to FIG. 6, any of a variety of systems and/or processes may be utilized in accordance with embodiments of the disclosure. In still yet additional embodiments, the process 600 may sense the at least one parameter and generate the actual sensor data after the retrieval of the predicted sensor data from the memory. The elements depicted in FIG. 6 may also be interchangeable with other elements of FIGS. 1-5 and 7-8 as required to realize a particularly desired embodiment.

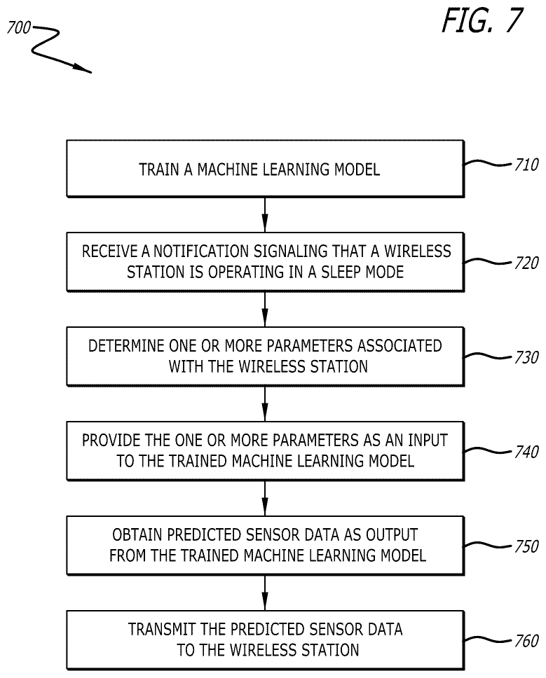

Referring to FIG. 7, a flowchart showing a process 700 for facilitating power conservation in a wireless device in accordance with various embodiments of the disclosure is shown. In many embodiments, the process 700 can train a machine learning model (block 710). In numerous embodiments, an AP is communicatively coupled to the wireless device. The machine learning model may be trained based on historical sensor data associated with a wireless device and at least one of a location, a time of day, one or more environmental conditions, or a scheduled target wake time corresponding to the historical sensor data. The historical sensor data may refer to sensor data generated by a sensor in the wireless device during past scheduled TWTs associated with the wireless device. In numerous additional embodiments, the machine learning model may be trained at the AP. In many further embodiments, the machine learning model can be trained at another device. Examples of the machine learning model may include decision trees, random forests, support vector machines, naïve Bayes, Seasonal and Trend decomposition using Loess, or K-nearest neighbors' algorithms. In several embodiments, the machine learning model may correspond to a hybrid machine learning model. In an example, the hybrid machine learning model may combine capabilities of Random Forest and Seasonal and Trend decomposition using Loess.

In a number of embodiments, the process 700 can receive a notification signaling that the wireless device is operating in a sleep mode (block 720). The process 700 may receive the notification in response to polling. The AP may perform polling to determine a status of the wireless device. The wireless device may operate in one of the sleep mode and a wake mode, at a given time. The notification may signal that the wireless device is operating in the sleep mode as the wireless device may be operating in the sleep mode when the AP performed polling. In several more embodiments, the AP may periodically perform polling.

In a variety of embodiments, the process 700 can determine one or more parameters associated with the wireless device (block 730). The one or more parameters may include at least one of a location of the wireless device, a time of day, one or more environmental conditions associated with the wireless device, or a scheduled target wake time associated with the wireless device. The AP may determine the one or more parameters upon receiving the notification from the wireless device.

In more embodiments, the process 700 may provide the one or more parameters as an input to the trained machine learning model (block 740). A location of a wireless device may correspond to at least one of a latitude and a longitude associated with the wireless device, a distance from the AP 102, or the like. One or more environmental conditions may include weather conditions (such as rain, humidity, fog, or snow), temperature, environmental noise, network congestion, physical obstacles, or the like.

In still yet further embodiments, the process 700 can obtain predicted sensor data as an output from the trained machine learning model (block 750). The trained machine learning model may process the one or parameters received as the input and output the predicted sensor data. The predicted sensor data may correspond to a prediction of forthcoming sensor data from the wireless device.

In additional embodiments, the process 700 can transmit the predicted sensor data to the wireless device (block 760). In still more embodiments, the predicted sensor data may be transmitted to the wireless device prior to an upcoming TWT associated with the wireless device. In still yet more embodiments, the predicted sensor data may be transmitted to the wireless device during a TWT associated with the wireless device. A determination to whether switch the transceiver from the sleep mode to a wake mode is based on the predicted sensor data. The transceiver may be maintained at the sleep mode when the predicted sensor data deviates from actual sensor data generated by the wireless device below a threshold value. Thus, the transceiver of the wireless device remains in the sleep mode for a longer duration resulting in enhanced power efficiency of the wireless device.

Although a specific embodiment for the process 700 for facilitating power conservation in a wireless device suitable for carrying out the various steps, processes, methods, and operations described herein is discussed with respect to FIG. 7, any of a variety of systems and/or processes may be utilized in accordance with embodiments of the disclosure. In still further embodiments, the AP may provide historical sensor data received by the wireless device to a cloud server or any other server for training the machine learning model and the AP can receive a local version of the trained machine learning model for execution. In some more embodiments, the AP may receive the predicted sensor data from the cloud server in comparison to receiving the local version of the trained machine learning model. The elements depicted in FIG. 7 may also be interchangeable with other elements of FIGS. 1-6 and 8 as required to realize a particularly desired embodiment.

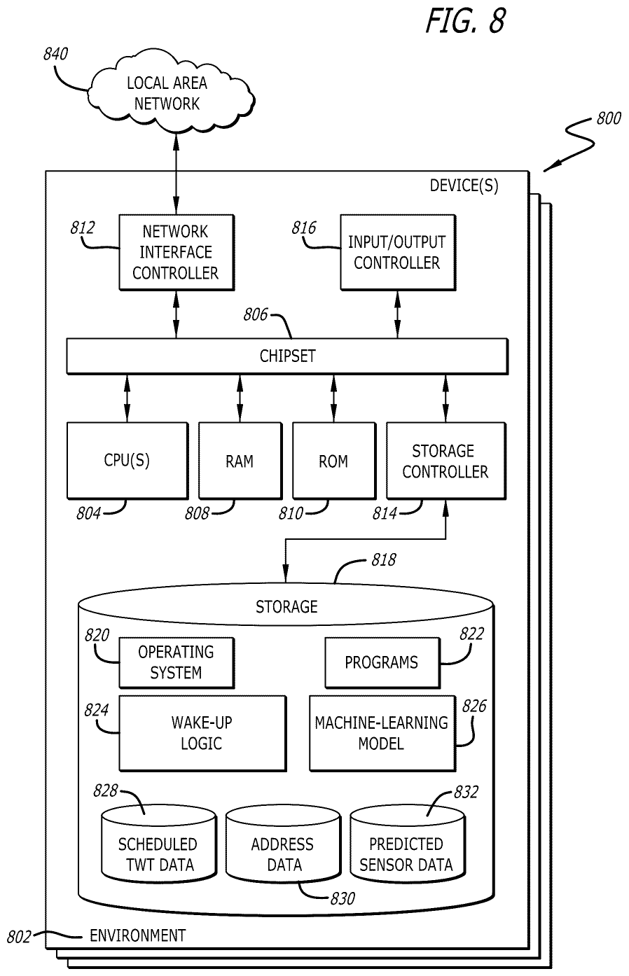

Referring to FIG. 8, a conceptual block diagram of a device 800 suitable for configuration with a wake-up logic in accordance with various embodiments of the disclosure is shown. The embodiment of the conceptual block diagram depicted in FIG. 8 can illustrate a conventional server computer, workstation, desktop computer, laptop, tablet, network device, access point, a wireless device, router, switch, e-reader, smart phone, centralized management service, or other computing device, and can be utilized to execute any of the application and/or logic components presented herein. The device 800 may, in some examples, correspond to physical devices and/or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In additional embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In further embodiments, the chipset 806 may provide an interface between the processor(s) 804 and the remainder of the components and devices within the environment 802. The chipset 806 can provide an interface to communicatively couple a random-access memory (“RAM”) 808, which can be used as the main memory in the device 800 in several embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Different embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for example, store an operating system 820, programs 822, wake-up logic 824, a machine-learning model 826, scheduled TWT data 828, address data 830, and predicted sensor data 832, which are described in greater detail below. The storage 818 can be connected to the environment 802 through a storage controller 814 connected to the chipset 806. In several more embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

For example, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to the device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In various embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as programs 822 and transform the device 800 by specifying how the processor(s) 804 can transition between states, as described above. In yet more embodiments, the device 800 has access to computer-readable storage media storing computer-executable instructions which, when executed by the device 800, perform the various processes described above with regard to FIGS. 1-7. In more embodiments, the device 800 can also include computer-readable storage media having instructions stored thereupon for performing any of the other computer-implemented operations described herein.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

In many embodiments, the device 800 can include the wake-up logic 824 that can be configured to perform one or more of the various steps, processes, operations, and/or other methods that are described above. Often, the wake-up logic 824 can be a set of instructions stored within a non-volatile memory that, when executed by the controller(s)/processor(s) 804, can carry out these steps, etc. In several embodiments, the wake-up logic 824 may be a client application that resides on a network-connected device, such as, but not limited to, a server, switch, personal or mobile computing device in a single or distributed arrangement. In several more embodiments, the wake-up logic 824 can be a dedicated hardware device, cloud-based service, or be configured into a system on a chip package (FPGA, ASIC and the like).

In a number of embodiments, the storage 818 can include the scheduled TWT data 828. As discussed above, the scheduled TWT data 828 may include data associated with a set of scheduled TWTs associated with a wireless device. Communication with a wireless device may be established based on the scheduled TWT data 828. The scheduled TWT data 828 may be stored in the storage 818 based on a negotiation process between the device 800 and a network device (such as an AP or a wireless device).

In still more embodiments, the storage 818 can include address data 830. As discussed above, address data 830 may include at least one of a MAC address or an internet protocol (IP) address associated with a wireless device or an access point. The device 800 may utilize the address data 830 to establish communication with the wireless device or the AP. In still more embodiments, the storage 818 can include the predicted sensor data 832. As discussed above, the predicted sensor data may be retrieved from the storage 818 whenever required by the device 800. In numerous embodiments, the predicted sensor data 832 may be transmitted upon the retrieval. In several more embodiments, the predicted sensor data 832 can be utilized for a comparison operation upon the retrieval.

Finally, in many embodiments, data may be processed into a format usable by the machine-learning model 826 (e.g., feature vectors, etc.), and or other pre-processing techniques. The machine learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826. The ML model 826 may be configured to learn the pattern of a network's current setup and/or any security needs of various network devices and generate predictions, configurations, and/or confidence levels regarding disaster recovery of a network for workload protection and/or segmentation, etc. In numerous additional embodiments, the ML model 826 can be configured to determine which method of generating those predictions would work best based on certain conditions or with certain network devices.

The ML model(s) 826 can be configured to generate inferences to make predictions or draw conclusions from data. An inference can be considered the output of a process of applying a model to new data. This can occur by learning from at least the scheduled TWT data 828, the address data 830, and the predicted sensor data 832, and/or the underlying algorithmic data and use that learning to predict future configurations, outcomes, and needs. These predictions are based on patterns and relationships discovered within the data. To generate an inference, such as a determination on anomalous movement, the trained model can take input data and produce a prediction or a decision/determination. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes. The training set of the ML model(s) 826 can be provided by the manufacturer prior to deployment and can be based on previously verified data.

Although a specific embodiment for a device 800 suitable for configuration with the wake-up logic 824 suitable for carrying out the various steps, processes, methods, and operations described herein is discussed with respect to FIG. 8, any of a variety of systems and/or processes may be utilized in accordance with embodiments of the disclosure. For example, the device 800 may be in a virtual environment such as a cloud-based network administration suite, or it may be distributed across a variety of network devices such that each acts as a device and the wake-up logic 824 acts in tandem between the devices. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a transceiver operable in one of a sleep mode or a wake mode;
a sensor configured to:
sense at least one parameter; and
generate actual sensor data based on the at least one sensed parameter; and
a wake-up logic configured to:
receive predicted sensor data;
compare the predicted sensor data with the actual sensor data; and
determine whether to switch the transceiver from the sleep mode to the wake mode based on the comparison between the predicted sensor data and the actual sensor data.

2. The device of claim 1, further comprising an antenna coupled to the wake-up logic.

3. The device of claim 2, wherein the antenna is configured to:
receive the predicted sensor data; and
provide the predicted sensor data to the wake-up logic.

4. The device of claim 1, wherein the device is associated with a scheduled target wake time.

5. The device of claim 4, wherein the predicted sensor data is received during the scheduled target wake time.

6. The device of claim 4, wherein the predicted sensor data is received prior to the scheduled target wake time.

7. The device of claim 6, further comprising a memory coupled to the wake-up logic, wherein the memory is configured to store the predicted sensor data in response to receiving the predicted sensor data prior to the scheduled target wake time.

8. The device of claim 7, wherein prior to the comparison of the predicted sensor data with the actual sensor data, the wake-up logic is further configured to retrieve the predicted sensor data from the memory.

9. The device of claim 8, wherein the wake-up logic is further configured to retrieve the predicted sensor data from the memory during the scheduled target wake time.

10. The device of claim 4, wherein the sensor senses the at least one parameter and generates the actual sensor data during the scheduled target wake time.

11. The device of claim 4, wherein the wake-up logic determines whether to switch the transceiver from the sleep mode to the wake mode during the scheduled target wake time.

12. The device of claim 1, wherein the wake-up logic is further configured to transmit a notification signaling that the transceiver is operating in the sleep mode, and wherein the predicted sensor data is received in response to transmitting the notification.

13. The device of claim 1, wherein the wake-up logic determines to maintain the transceiver in the sleep mode in response to the predicted sensor data deviating from the actual sensor data below a threshold value.

14. The device of claim 1, wherein the wake-up logic determines to switch the transceiver from the sleep mode to the wake mode in response to the predicted sensor data deviating from the actual sensor data beyond a threshold value.

15. The device of claim 14, wherein in response to being switched to the wake mode, the transceiver is configured to transmit the actual sensor data.

16. A device, comprising:
a processor;
a network interface controller configured to provide access to a network; and
a memory communicatively coupled to the processor, wherein the memory comprises a wake-up logic that is configured to:
receive, from a network device, a notification signaling that the network device is operating in a sleep mode;
predict, in response to receiving the notification, sensor data associated with the network device; and
transmit the predicted sensor data to the network device, wherein a determination to switch the network device from the sleep mode to a wake mode is based on the predicted sensor data.

17. The device of claim 16, wherein the wake-up logic is further configured to:
determine one or more parameters associated with the network device;
provide the one or more parameters as an input to a trained machine learning model; and
obtain, based on the one or more parameters, the predicted sensor data as an output of the trained machine learning model.

18. The device of claim 17, wherein the one or more parameters include at least one of a location of the network device, a time of day, one or more environmental conditions associated with the network device, or a scheduled target wake time associated with the network device.

19. The device of claim 17, wherein the wake-up logic is further configured to train the machine learning model based on historical sensor data associated with the network device and at least one of a location, a time of day, one or more environmental conditions, or a scheduled target wake time corresponding to the historical sensor data.

20. A method, comprising:
sensing at least one parameter;
generating actual sensor data based on the at least one sensed parameter;
receiving predicted sensor data;
comparing the predicted sensor data with the actual sensor data; and
determining whether to switch a transceiver of a device from a sleep mode to a wake mode based on the comparison between the predicted sensor data and the actual sensor data.
